(19) United States
(12) Patent Application Publication
(10) Pub. No.: US 2025/0059833 A1
(43) Pub. Date: Feb. 20, 2025

(54) Rooftop Platform - SafetyPitch

(71) Applicants: Robert Manganelli, Queen Anne, MD (US); Michael Mastalir, Whitefish Bay, WI (US)

(72) Inventors: Robert Manganelli, Queen Anne, MD (US); Michael Mastalir, Whitefish Bay, WI (US)

(21) Appl. No.: 18/449,906

(22) Filed: Aug. 15, 2023

(51) Int. Cl. E06C 7/16; E06C 5/36; E06C 7/44; E06C 7/48

(52) U.S. Cl. CPC E06C 7/16; E06C 5/36; E06C 7/44; E06C 7/488

(57) ABSTRACT

A handheld, portable ladder anchoring system designed for pitched roofs or other pitched constructs, that secures ladder placement in all directions via a 360-degree ladder stop. Platform configuration embodies a tripodal, load bearing design of tangential contact points of ladder feet abutting the inner rim of the ladder stop with a third leg of tripodal force-distribution being a tie-down strap.

### CROSS REFERENCE TO RELATED APPLICATION

This non-provisional utility patent application claims the benefit of and priority to provisional patent application No. 63/454,615, filed on Mar. 24, 2023, entitled: ‘Rooftop Platform-SafetyPitch’ The entire disclosure of the provisional application is incorporated herein by reference.

### FIELD OF THE INVENTION

The present disclosure introduces a safe, secure and efficient method for anchoring and navigating ladders on pitched roofs and similar inclined structures. It finds applications in residential and commercial roofing, construction, solar panel installation, as well as set construction and rigging for media and entertainment operations. This invention caters to the needs of homeowners and industries alike, utilizing horizontal platforms for anchoring ladders, scaffolding, and other devices in pitched roof construction, restoration, installation, maintenance, repair, and siding applications. Its integration into workflows within these industries can lead to improved safety and productivity in various applications related to pitched roof environments.

### BACKGROUND OF INVENTION

### Safety Challenges in Roofing Work

The roofing industry is fraught with substantial risks, with fatal incidents predominantly attributed to falls, slips, and trips. Safety is of paramount importance for workers navigating a rooftop-safety to themselves and also for anyone in their proximity, standing around or below them. Lifting and repositioning heavy ladders or scaffolding supports while balancing on a pitched roof can pose significant risks. However, these responsibilities are commonly undertaken by roofing professionals and insurance adjusters as part of their daily routine.

### High Risks and Fatalities in the Roofing Industry

Roofing is one of the top three deadliest occupations. Exposure to fall hazards makes roofing among the most dangerous jobs in construction. The roofing fatality rate is 13 times higher than the average. Falls from heights are the highest cause of death for roofing contractors. The highest cause of death for roofing workers in general is also falls from heights. It is crucial for roofing contractors to prioritize safety. Of the top ten most frequently cited OSHA standards violations in 2021: (1st) Fall protection, construction. (3rd) Ladders, construction, and (5th) Scaffolding, construction.

This simple invention is born out of a simple, solemn purpose and from regulatory codes themselves: to protect lives and ensure workplace safety.

### Compliant Design Features for Portable Ladders

This section presents an overview of the design features incorporated in the Present Invention ladder anchoring system (“Present Invention”), emphasizing its adherence to recognized safety codes and guidelines for portable ladders. The compliance of the Present Invention extends beyond the requirements outlined by regulatory bodies, demonstrating its commitment to exceeding prevailing safety regulations. The following regulations and standards are encompassed within the Present Invention's design framework:

Occupational Safety and Health Administration (OSHA) Regulations: (a). OSHA Regulation 1917.119(f)(8): The Present Invention ensures secure positioning of ladders on a level and firm base. (b). OSHA Regulation 1917.119(f)(9): The Present Invention guarantees slip-resistant bases and secure bottom attachment to prevent slipping. A tire-grade, non-slip membrane on the platform enhances compliance. (c). The Present Invention strictly adheres to OSHA's precise “step-around distance” requirements for ladder to walking plank or scaffolding transitions. (d). Although OSHA Subpart X (29 CFR 1926.1050 et seq) does not mandate fall protection for workers on portable ladders, the Present Invention incorporates housing and support for scaffolding systems, aligning with OSHA recommendations. (e). The Present Invention ensures compliance with OSHA's directive on “secure footing support for ladders, even on uneven surfaces.” (f). The Present Invention aligns with OSHA's requirement for “platform or landing between ladders when accessing elevated work areas using multiple ladders.”

California Title 8 Code of Regulations: (a). The Present Invention recognizes and complies with Portable Ladder Safety: (T8CCR) Sections 1675, 3276, 3287, and 3413. It ensures “safe access to all elevations using ladders unless suitable alternatives are available.” (b). The Present Invention adheres to TSCCR Section 3276(e)(7) by “placing ladder bases on secure and level footings while avoiding unstable bases.” (c). The Present Invention incorporates “platforms or landings between multiple ladders,” as required by T8CCR Section 3276(e)(10).

American National Standards Institute (ANSI) Standards: The Present Invention incorporates and acknowledges ANSI standards A14.1-2007, A14.2-2007, A14.5-2007, and A14.10, referenced in Section 3276 of the California Code of Regulations.

The Present Invention further adheres to the relevant provisions outlined in T8CCR, Sections 1675, 3276, 3287, and 3413. These sections govern Portable Ladder Safety 3276 and reference ANSI standards A14.1-2007, A14.2-2007, A14.5-2007, and A14.10. It emphasizes the use of ladders for safe access, secure and level footing placement, and platform or landing inclusion between multiple ladders.

Canadian Centre for Occupational Health and Safety (CCOHS) Recommendations: The Present Invention aligns with CCOHS recommendations for “portable ladders,” which specifically emphasizes, “Bottom Bracing” and instructs user to: “(a). Place the ladder on a firm, level footing. (b). Use a ladder with slip-resistant feet or secure blocking. (c). “Brace or Tie the bottom of the ladder.” The Present Invention incorporates a non-slip, 360-degree ladder stop base and a heavy-duty “tie-down” strap for enhanced securement, informed by CCOHS guidelines.

The present invention presents a lightweight, robust, and versatile ladder base anchoring system that provides a horizontal base for securely setting, anchoring, and scaling a ladder in all directions and angles. It enables ground-to-pitch, pitch-to-pitch, and pitch-to-platform ladder navigation, accommodating pump jack systems, poles, and walking planks, and offering a versatile solution for various construction and maintenance tasks.

### Prioritizing Safety and Efficiency with the Present Invention

The present invention prioritizes safety and efficiency by minimizing platform tasks and eliminating the need to lift and reposition heavy ladders during rooftop work. By simplifying setup and streamlining functionality, it optimizes safety, saves time, and enhances overall efficiency. This deliberate focus on operational simplicity and mechanics can ensure a safer working environment while maintaining key mechanical benefits.

### Quick and Secure Attachment for Efficient Roof Work

The invention enables quick and secure attachment to roofs or pitched structures, eliminating the need for lengthy setup times. It facilitates efficient dismantling after completing tasks, allowing for seamless transitions between setup, project execution, and removal on roofs or pitched constructs.

### Solar Panel Installation

In addition to traditional roofing applications, solar panel installation on rooftops continues to advance. It is evident that incorporating both functional and aesthetic elements with intricate multi-angular and multi-directional schemes can have significant implications for future applications. The integration of solar panels into roofing structures presents a clear opportunity for widespread adoption of clean energy solutions. To support these roofing applications, specialized tools and equipment will be required for installation, maintenance, repair, and replacement. The present invention can address this need by offering omni-directional ladder sets and pitched-centric pump jack and scaffolding configurations. It can provide the necessary optimization for the surging traffic on ladders in the context of emerging clean energy technologies. With the growing demand for versatile and flexible access solutions, the present invention can ensure safe and adaptable access, enabling efficient handling of advancements in solar power designs and the anticipated increase in ladder traffic.

### The Roofing Industry in the Clean Energy Era

Given this constantly evolving market, technologies, and the expanding government policy environment, the roofing industry will be at the forefront of defining and redefining the commercialization of clean energy within commercial and residential constructs.

### Versatile Application in Set Building and Event Industries

Set building for film, television, theater, concerts, and conventions often requires navigating non-standardized pitch configurations and angles without architectural plans. The present invention's 360-degree ladder stop enables secure ladder positioning at any angle and can provide safe, efficient, and easy maneuverability, specifically designed to accommodate improvised, “on the fly” conditions.

### Addition Use

The present invention may cater to a wide range of professionals who require safe and efficient navigation on pitched roofs, including architects, builders, and various other individuals involved in tasks such as assessing structures, conducting inspections, performing maintenance, and executing construction projects. Whether it's assessing the condition of a roof, inspecting architectural features, measuring dimensions, accessing specific areas, or performing tasks such as chimney work, skylight installation and maintenance, gutter maintenance, roof inspections, painting and coating applications on roofs, satellite dish installation, HVAC system maintenance, roof repairs and maintenance, accessing hard-to-reach areas on roofs, sealing and cleaning tasks, or engaging in construction projects involving pitched roofs, the platform provides a secure means of transitioning from the ground-to-pitch, pitch-to-pitch, or pitch-to-platform ladder navigation. Its adaptability and anchoring system can be a valuable tool for anyone who needs to work at heights while ensuring stability and minimizing risks associated with working on inclined surfaces.

### Drawbacks of Previously Utilized Methods

Existing patents, such as the one by Garrett, Roofmates Inc. (U.S. Pat. No. US20030230451A1), provide partial resemblances to the functionalities offered by the invention but lack full, 360-degree anchored maneuverability.

Garrett's bolt-and-nut configuration enables ladder positioning in only four directions, requiring the ladder to be lifted, realigned into different, maze-like compartments, and re-fastened with nuts and bolts for relocation. This process is cumbersome, adds extra tasks, and increases associated risks.

Garrett's platform configuration incorporates 16 setting compartments, organized into eight pairs, allowing for eight distinct ladder sets. However, its square configuration restricts it to accommodating only four right angles. Each directional change requires a laborious process of lifting, realigning, relocating, and re-fastening four nuts and bolts. Maneuvering the ladder's feet into the tight-fitting compartments on a roof is challenging and risky.

In contrast, the present invention introduces a simplified 360-degree ladder stop that eliminates the need for compartments and the use of nuts and bolts. With the simplified ladder stop, ladder sets can be easily positioned in any desired direction, streamlining rooftop operations and enhancing safety and ease of use. The invention's design can mitigate the risks associated with intricate ladder positioning and reconfiguration, creating a more secure and efficient work environment.

Garrett's platform requires additional steps to accommodate different pitch settings, including activating pin locks and engaging nut and bolt connections. In comparison, the present invention features a commercial-grade “Pivot Bracket” with a heavy duty “Retainer Ring” and a welded, Cross-Bar Rod that securely holds the base flange captive in the pivot bracket's notch slot configuration. The invention also incorporates a hinged connection between the base platform and linkage bracket for easily setting a level pitch. This innovative configuration can enhance safety and simplicity, providing a more efficient and user-friendly solution.

Garrett's complex configuration increases the time and effort required for adjustments and raises the risk of errors during ladder repositioning. The limited directional options and extensive setup process can hinder efficiency and may pose safety concerns during construction, installation, and maintenance activities.

### Lack of any Equivalent or Similar Platform Anchoring Systems

The market research conducted indicates that only Garrett's platform provides a partial resemblance to the functionalities offered by our invention. However, no other device or system has been found that provides the same comprehensive features and benefits as our novel platform anchoring system. This absence of comparable solutions underscores the potential for our invention to make a substantial impact on the industry by filling a critical gap in the market. Its unique mechanical design and capabilities can position it as a leading solution, offering significant advantages and setting a new standard for platform attachment mechanisms in terms of safety, stability, and versatility.

### FEATURES OF THE INVENTION

The present invention addresses the aforementioned concerns by employing a precisely engineered device consisting of:

### Operational Simplicity and Mechanics

By repositioning the ladder on a 360-degree open ladder stop, the invention can achieve enhanced functionality and ease of use. This advancement minimizes tasks and as a result, can improve safety during setup and operation. With the elimination of compartments, nuts and bolts, the invention streamlines the process, emphasizing its commitment to operational simplicity and mechanics. Ultimately, it offers a solution that can save lives.

### Quick and Secure Attachment for Time-Saving Construction

The present invention can be quickly and securely attached to roofs or other pitched structures, eliminating the need for lengthy setup times before starting construction, repairs, replacements, painting, or other maintenance projects.

Moreover, it facilitates efficient dismantling after completing the desired tasks, saving additional time and effort. This streamlined process allows for seamless transitions between setup, project execution, break-down and removal on roofs or pitched constructs.

### Compatibilities with Existing Ladder Safety Accessories

The present invention can effectively integrate with existing ladder safety accessories, enhancing its mechanical functionality and versatility. By combining with these accessories, it can become a centerpiece solution that can be customized for various safety requirements. This mechanical integration improves the overall adaptability of the invention, allowing users to incorporate it alongside their preferred accessories.

Ladder hooks or stabilizers. The invention features an adjustable support bracket that securely sets the ladder stop platform in a stable and horizontal position. This can ensure secure ladder placement and stability when attaching ladder hooks or stabilizers.

Ladder levelers. The invention incorporates a tiltable and securely fastened adjustable support bracket that maintains the platform's horizontal orientation, even on uneven surfaces. This compatibility allows for the attachment of ladder levelers, providing stability and safety across various terrains.

Ladder stand-offs. The invention's circular ladder stop accommodates ladders of varying widths. By firmly supporting the ladder feet against the inner rim of the ladder stop, the platform enhances stability, facilitating the attachment of ladder stand-offs.

Walking planks. The invention incorporates engineered attachment points for secure fastening of walking planks. These independent platforms extend the working surface, enabling safe movement and enhancing versatility, functionality, and stability during navigation on and off the anchored ladder.

Ladder safety accessories. By incorporating a non-slip rubber membrane securely attached to the underside of the base plate, the risk of sliding or slipping on pitched roof surfaces is eliminated. Additionally, this feature stabilizes the invention during attachment to the roof using its nail bed, while also simplifying the process of adding ladder accessories such as stabilizers, mitts, or guards.

By offering compatibility with existing ladder accessories, the invention maximizes functionality during ladder navigation on pitched roofs or inclined structures. Users can effectively utilize the advantages of these accessories to enhance stability, prevent accidents, and ensure secure ladder placement, ultimately leading to overall efficiency improvement.

### SUMMARY

The presented invention is a lightweight, portable, and adjustable horizontal platform designed for secure ladder navigation on pitched roofs and similar structures. It offers versatility in adapting to numerous pitch configurations, allowing users to achieve a stable and horizontal base. The platform's commitment to safety extends beyond its inherent design. By adhering to various safety regulations and standards, including those set by regulatory bodies such as OSHA, the California Code of Regulations, ANSI, and the CCOHS.

Featuring a novel 360-degree ladder stop, the platform can ensure safe, ladder climbing on any pitched configuration and from any angle or orientation, delivering exceptional performance and stability. Reinforced materials and anti-slip surfaces further enhance durability and provide secure footing during use.

The collapsible design enables effortless and timely setup, breakdown, and compact storage, enhancing the platform's portability. With its versatility, users can confidently maneuver on steep roofs, ensuring comfort and security. The platform prioritizes safety and grants access to hard-to-reach areas, making it an efficient roofing solution for professionals and homeowners.

Additionally, the platform integrates with ladder safety accessories such as hooks, levelers, stand-offs, and planks, providing a comprehensive safety solution.

Catering to a wide range of applications, including residential and commercial roofing, construction, solar panel installation, and media and entertainment set building, this platform offers adaptability and versatility. By addressing safety concerns and facilitating access to challenging areas, it can significantly enhance workplace efficiency and ensures safety for all users.

### BRIEF DESCRIPTIONS DRAWINGS

FIG. 1: Overall view of the present invention depicting its various components: (1) Nail beds to nail the invention to a roof or pitched structure. (2) Handle for carrying the platform. (3) 360-degree ladder stop with a non-slip membrane to provide secure ladder placement. (4) Pump pack housing for the hydraulic system. (5) Upper platform with 360 degree ladder stop. (6) Wood screw holes to secure the walking plank in place. (7) Walking plank housing to accommodate the walking plank. (8) Tie-down strap and drainage slot for securing the platform and allowing water drainage. (9) Lower support platform for stability. (10) Adjustable pivot linkage bracket for adjusting the platform's angle. (11) Adjustable pivot linkage crossbar that connects to the pivot linkage bracket. (12) Roof bracket mechanism embodying notches that capture and secure the pivot bracket crossbar. (13) Heavy-duty retainer ring for securing the components. (14) Adjustable pivot bracket base to provide a stable base for the pivot linkage bracket.

FIG. 2: View of the present invention's collapsed and carry configuration including: (1) Carrying handle. (2) Nail bed holes. (3) Wood screw holes to secure the walking plank in place. (4) Jack pump housing for the hydraulic system. (5) Walking plank housing. (6) 360-degree ladder stop with a non-slip membrane.

FIG. 3: View of a ladder secured atop the 360-degree “ladder stop” depicting: (1) Ladder feet securely fixed on the non-slip platform and buttresses against the inner rim of the ladder stop. (2) Walking plank housing. (3) Heavy-duty tie-down with ratchet. (4) Rim of the 360-degree ladder stop. that securely buttresses both ladder legs against the inner circumference of the circular stop, forming two sides of the triangular anchor design, allowing for secure ladder placement in any desired direction.

FIG. 4: View of a heavy-duty tie-down strap with a ratchet depicting: (1) The strap's fastening around the first ladder rung. (2) Ratchet for loosening and tightening. (3) Tie-down and drainage slot to secure the ladder to the 360-degree ladder stop, capable of ladder sets in any direction.

FIG. 5: Itemized break-out of the current invention's component parts including: (1) Non-slip membrane. (2) 360-degree ladder stop and platform. (3) Adjustable pivot bracket. (4) Hinge mechanism connecting the adjustable pivot bracket to the horizontal platform. (5) Roof bracket base. (6) Non-slip grip material securing utility to pitched construct.

FIG. 6: Adjustable Pivot Bracket: (1) At zero-degree position (flat). (2,3,4) Adjustments for progressively, steeper pitches.

FIG. 7: Detail of the adjustable pivot bracket “lock-in” configuration including: (1) Heavy-duty retainer ring that secures the rod into the grip points for interlocking crossbar. (2,3) Interior support plate.

FIG. 8: Detailed view of pivot bracket, including: (1) mounting holes (attachment to upper platform). (2) Heavy duty retainer ring. (3) cross bar.

FIG. 9: Top view of the platform including: (1) Jack pump housing. (2) Base platform. (3) 360-degree ladder stop. (4) Underside walking plank housing. (5) Lateral rib structural truss support configuration.

FIG. 10: Structural lateral rib consisting of: (1) Walking plank housing. (2) Triangular truss support bracing strut. (3) Spacing wedges. (4) Cross strut.

FIG. 11: Top view of a center weighted pump jack housing (square post anchor), with the pump jack pole in the operational position and (1) Another view of the walking plank housing.

FIG. 12: Top view of base plate configuration: (1) Front view. (2) Backside view when flipped over.

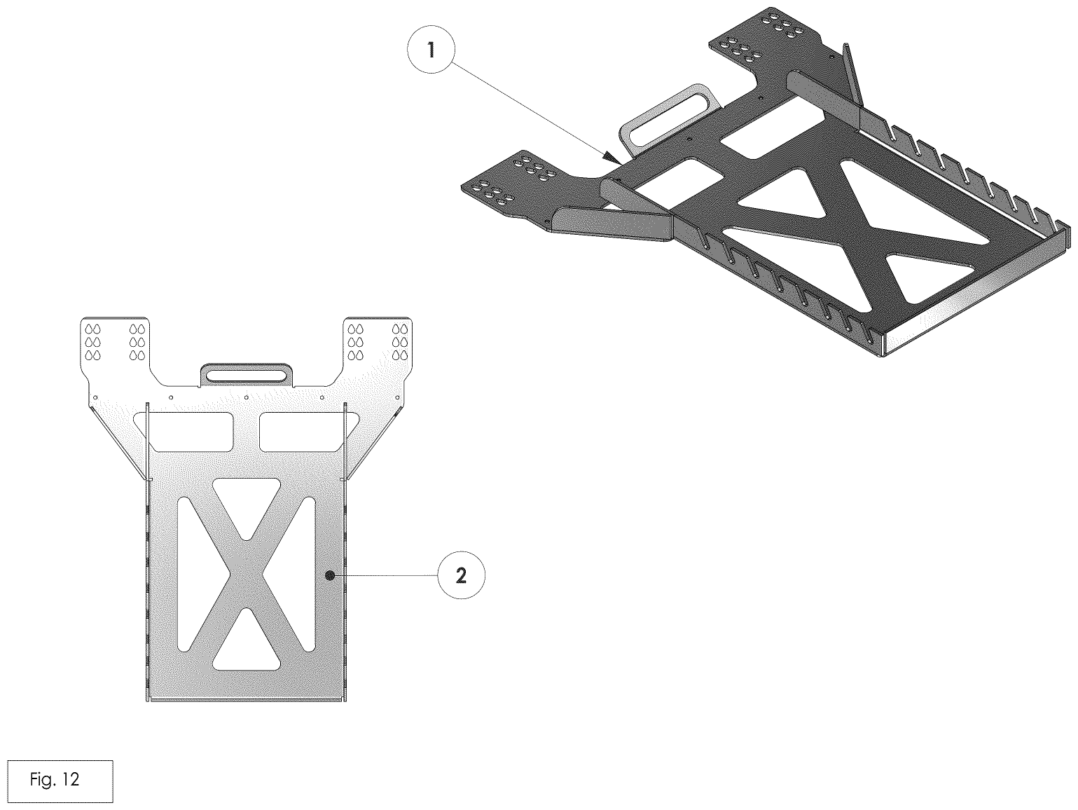

FIG. 13: Underbelly view of base plate featuring a tire-grade, high-grip, non-slip surface.

FIG. 14: Close-up detail of the present invention's nail bed in an operational position, securely nailed beneath a roof tile.

FIG. 15: Walking plank configuration showing the option of using: (1) single 2×6 or (2), two 2×6′s.

FIG. 16: View of the present invention's operational ladder configuration: (1) Ground-to-pitch position. (2) Pitch-to-pitch position. (3) Zero angle position.

### DETAILED DESCRIPTION OF INVENTION

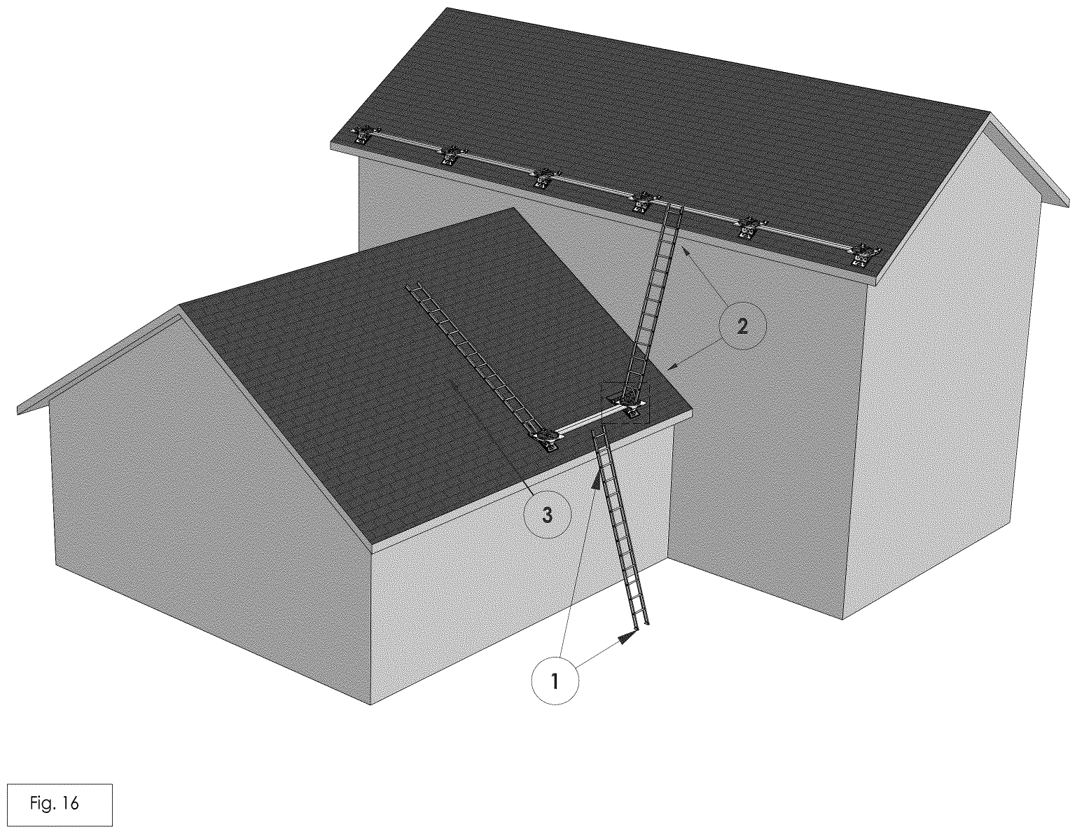

The present invention's configuration offers versatility for ladder navigation in different scenarios. In the ground-to-pitch configuration, the invention provides a secure horizontal base for setting, anchoring, and scaling the ladder on uneven surfaces. This can ensure safe and stable ladder navigation from the ground-to-pitch, as depicted in FIG. 16 (1), pitch-to-pitch, as shown in FIG. 16 (2), and pitch to platform.

For exceedingly steep pitches, the invention features a specialized “zero pitch” configuration as depicted in FIG. 16 (3). In this configuration, the ladder is placed flat against the roof, securely buttressed against the top of the base platform, and tied down using its heavy duty tie down, ratcheted strap attaching first ladder rung to the dual purpose, handle mechanism. To ensure utmost safety, ladder accessories such as ladder hooks are required to secure the top of the ladder.

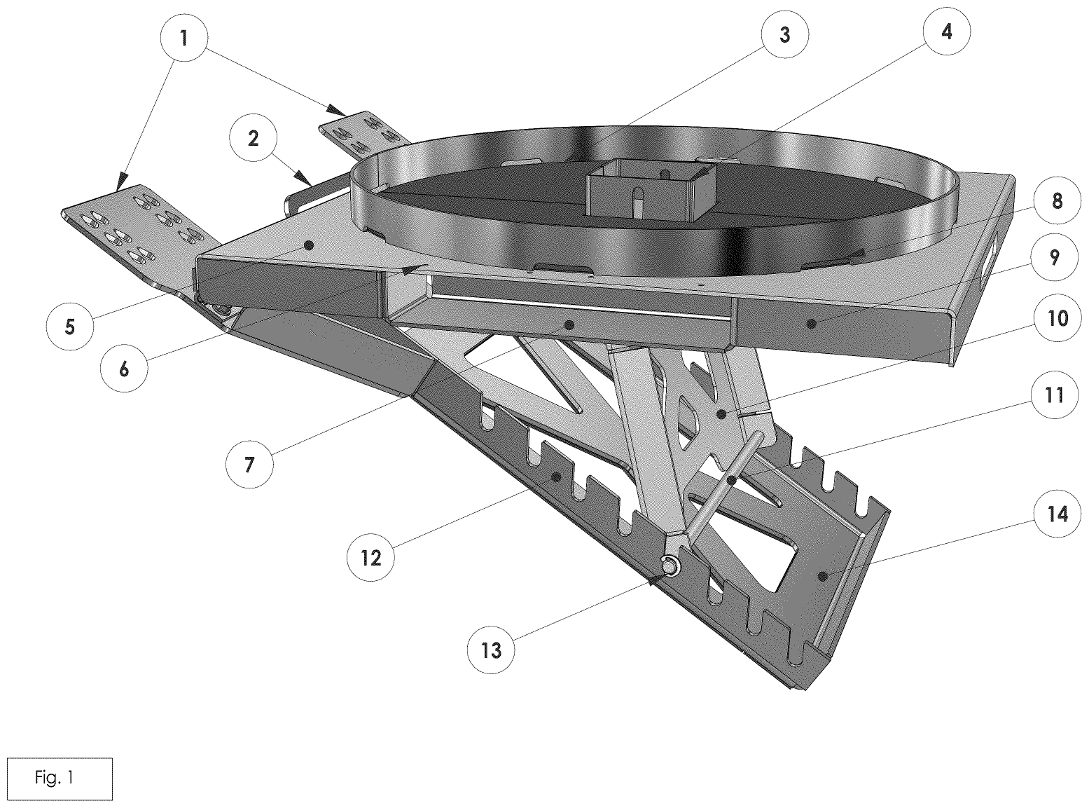

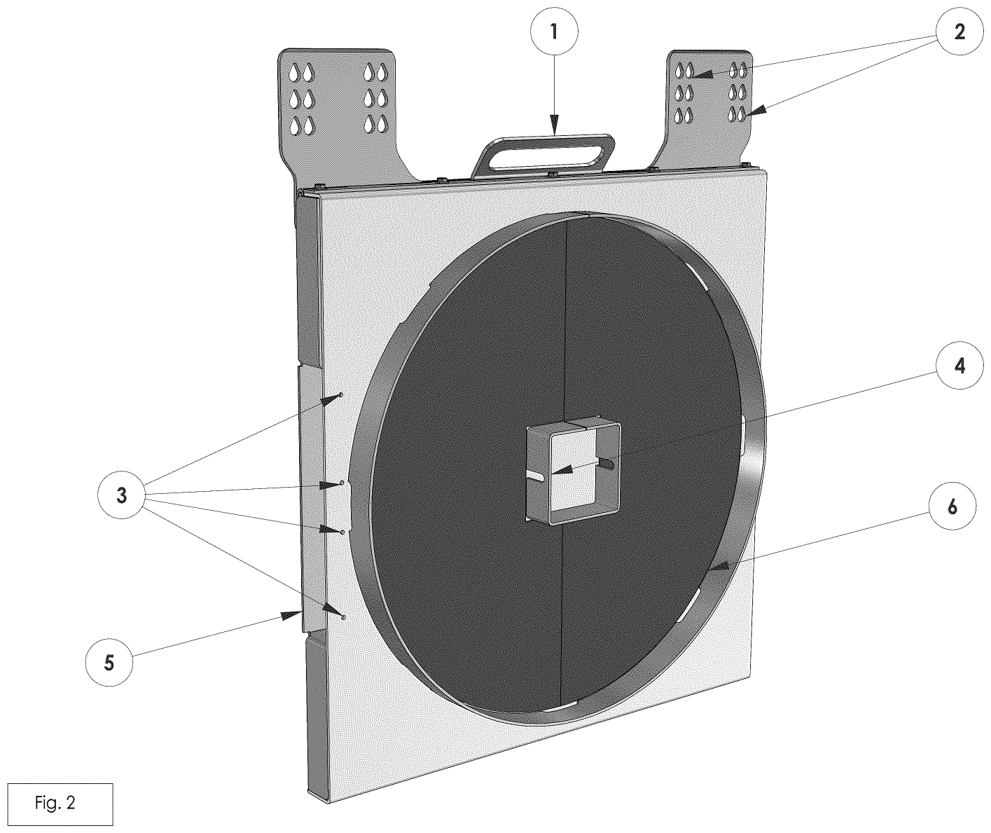

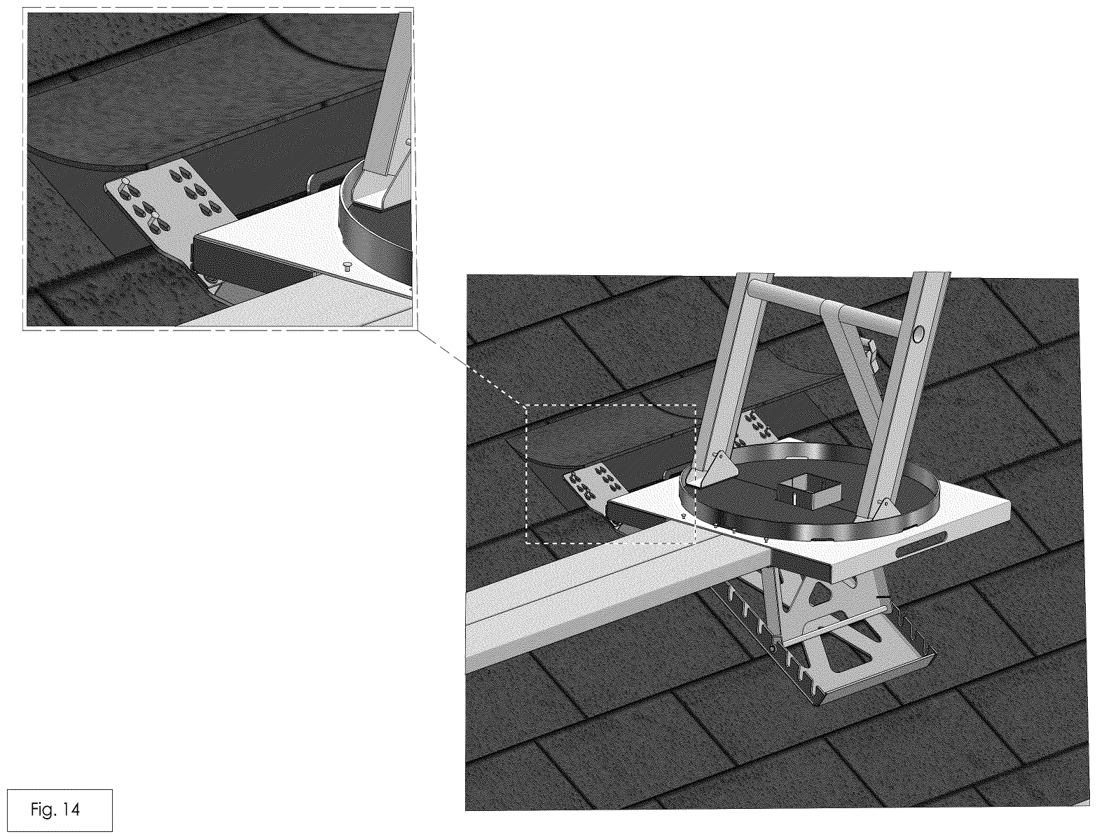

The present invention embodies a nail bed FIG. 1 (1), FIG. 2 (1), and FIG. 14, which consists of four vertical rows of pre-machined holes, arranged in two pairs. This design enables the adjustable platform to be securely attached to the roof, with options for standard joist separations of 12 and 16 inches “on center.”

Teardrop-shaped, pre-machined holes in the nail bed facilitate easy detachment by lifting the platform up and off the roof, FIG. 1 (1), FIG. 2 (2). These teardrop holes are specifically designed to accommodate the head of a nail or fastener, ensuring a secure hold during use. When it's time to remove the platform, the user can simply lift it vertically, disengaging the nails from the teardrop-shaped holes, FIG. 14. The nails are hammered in beneath the shingle, similar to the process of installing a new shingle. This design feature provides a straightforward and convenient method for lifting and removing the platform from the roof once the project is complete.

### Effortless Adjustment and Setup Process

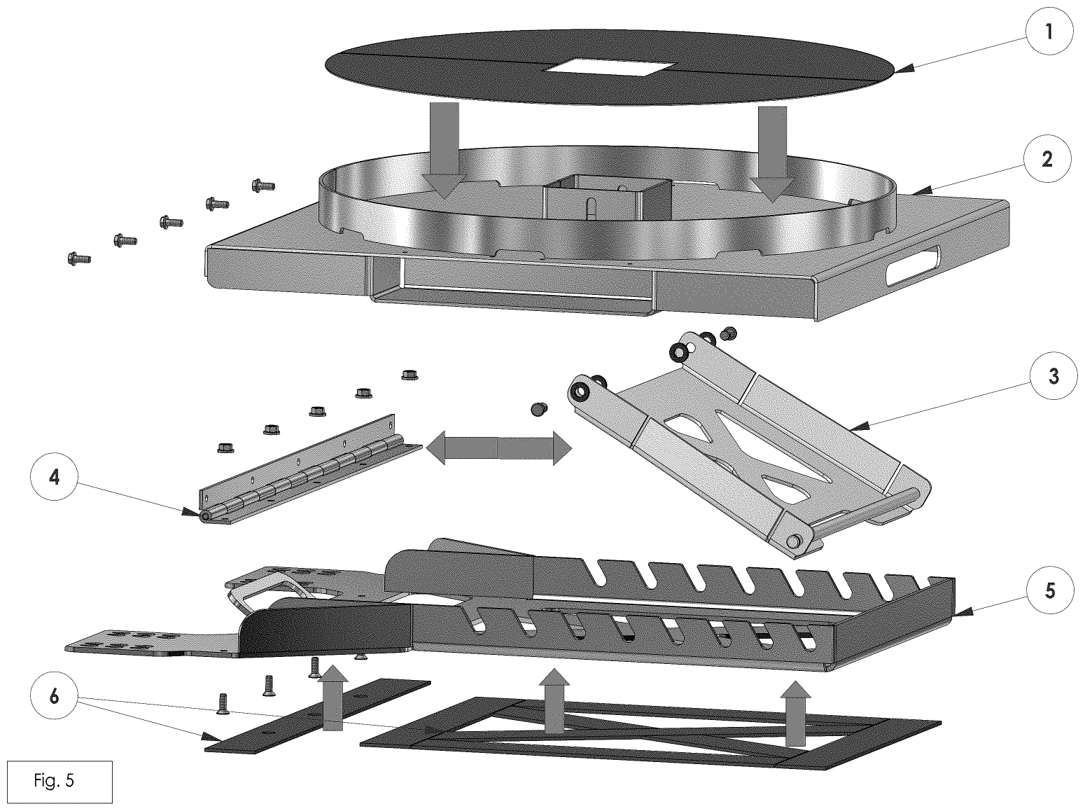

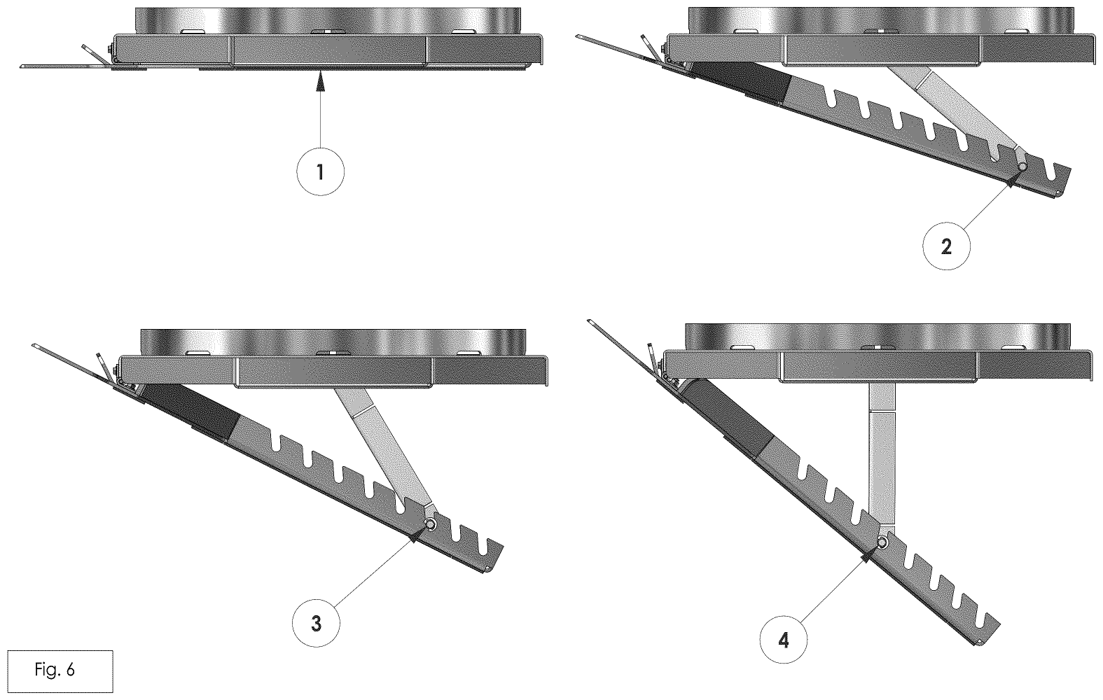

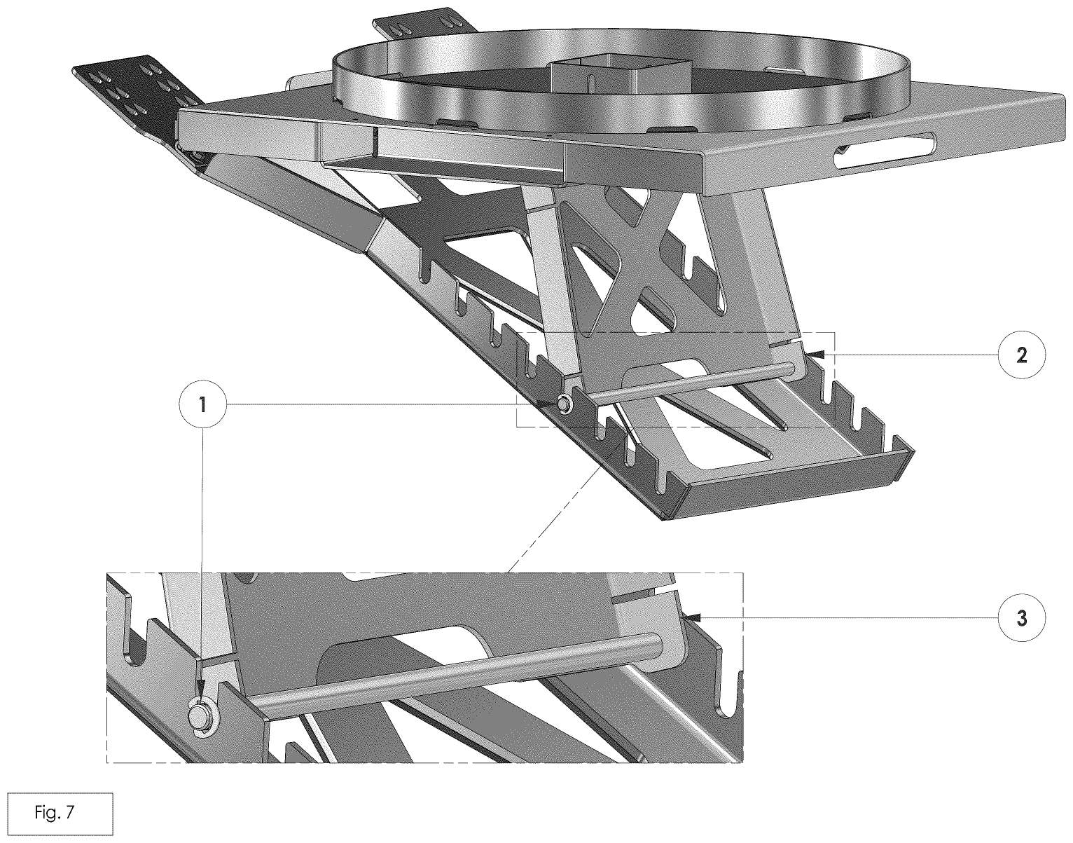

The base platform is equipped with a hinged mechanism FIG. 5 (3,4), that establishes a connection with the adjustable roof jack configuration, eliminating the requirement for manual nut-and-bolt adjustments. This functional feature enables effortless adjustment of the base platform to accommodate various pitch circumstances, providing flexibility and user-friendly operation, FIG. 6 (1,2,3,4). With the ability to swiftly and securely align the platform with the roof's specific angle and lock it down, FIG. 7, there is no need for intricate tightening procedures. By simplifying the setup process, this streamlined design enhances both user safety and operational efficiency.

### Enhanced Load-Bearing Configuration for Reliable Support of Heavy Loads

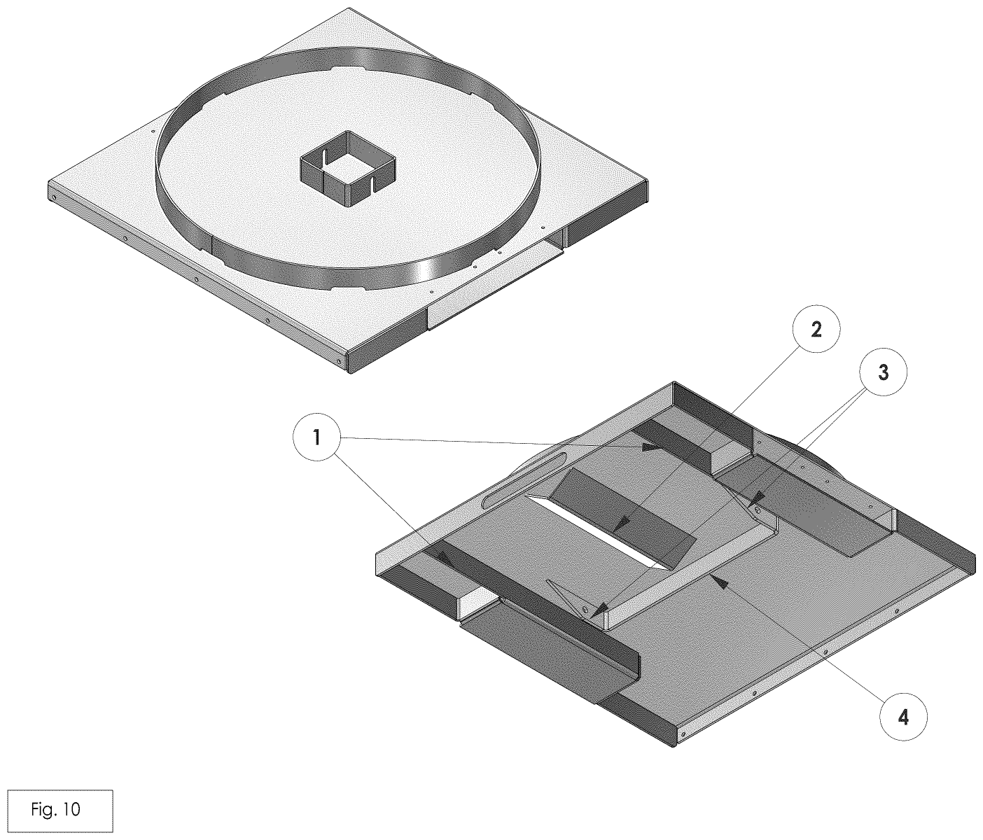

The base platform of the invention incorporates a reinforced structural configuration on its underside, specifically engineered to withstand heavy load capacities. This configuration includes a lateral rib, a horizontal, transverse inverted wedge-shaped element positioned between the upper and lower plates of the platform, FIG. 10 (2)). Constructed from formed sheet metal, the lateral rib features two wedges, FIG. 10 (3)) for clearance and includes holes for connecting the pivot bracket to the platform, along with a perpendicular truss support bracing strut, FIG. 10 (4)

By integrating this configuration, the invention significantly elevates its strength, stability, and load-bearing capacity. The lateral rib adds rigidity, effectively minimizing stress points and ensuring efficient distribution of applied loads. Its unique design allows the platform to withstand heavy loads while maintaining structural integrity. The combination of the inverted wedge and U-shaped elements facilitate even weight distribution, resulting in improved stability and reduced risks of structural failure or deformation.

### Cross Bar and Retainer Ring

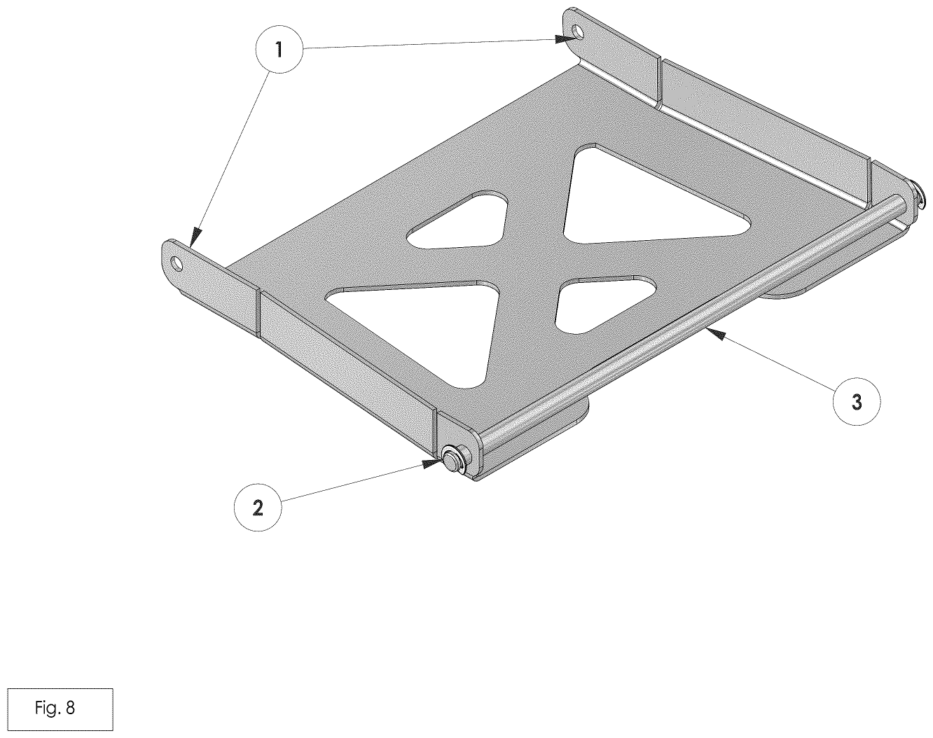

The present invention features a robust and durable retainer ring designed to secure, lock, or fasten the adjustable, pivot bracket in place, FIG. 1 (13), FIG. 8 (2). Positioned at the end of the crossbar, this retainer ring effectively prevents sliding or shifting of the crossbar during usage. It engages with the receiving bracket, establishing a secure locking mechanism that firmly fixes the crossbar in position. With the incorporation of the heavy-duty retainer ring, the invention can provide an enhanced level of security and reliability to the adjustable bracket assembly.

### Unique Platform Configuration with Non-Slip Ladder Stop

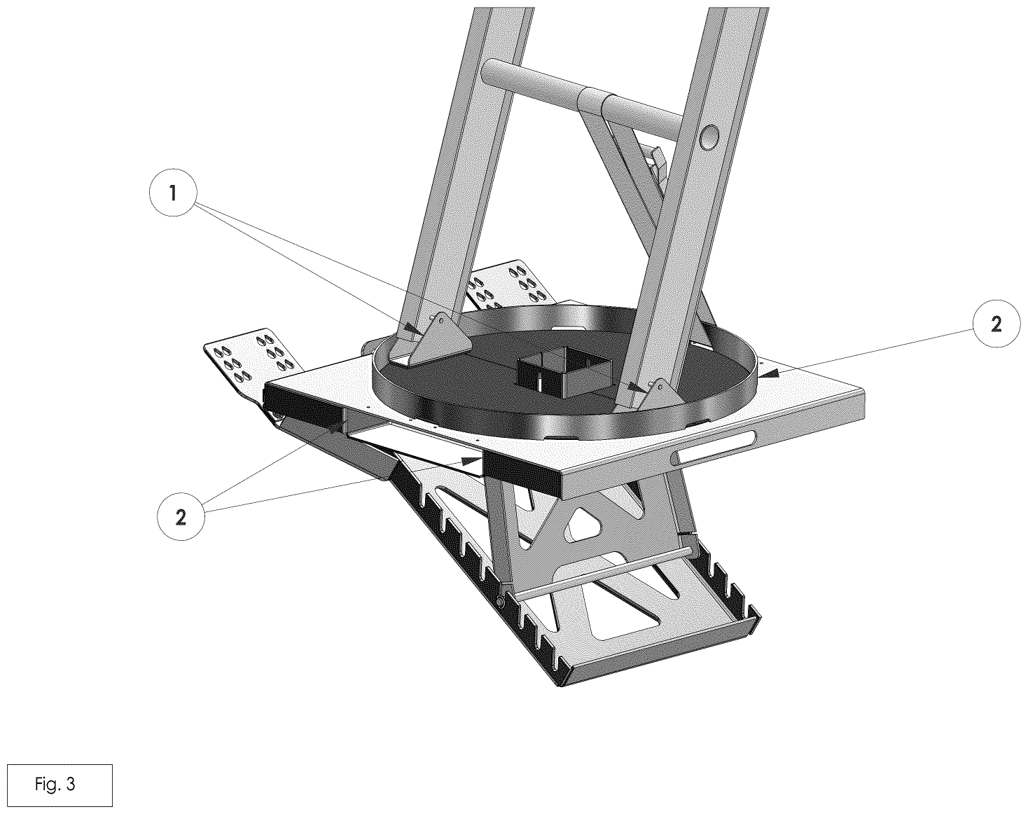

Perhaps the most novel embodiment of the present invention is its unique and minimalist platform configuration centered around a non-slip. 360-degree ladder stop FIG. 1 (3), FIG. 2 (6), FIG. 3 (2), FIG. 5 (1), and FIG. 5 (2). This innovative feature simplifies rooftop work by requiring only one ladder setup.

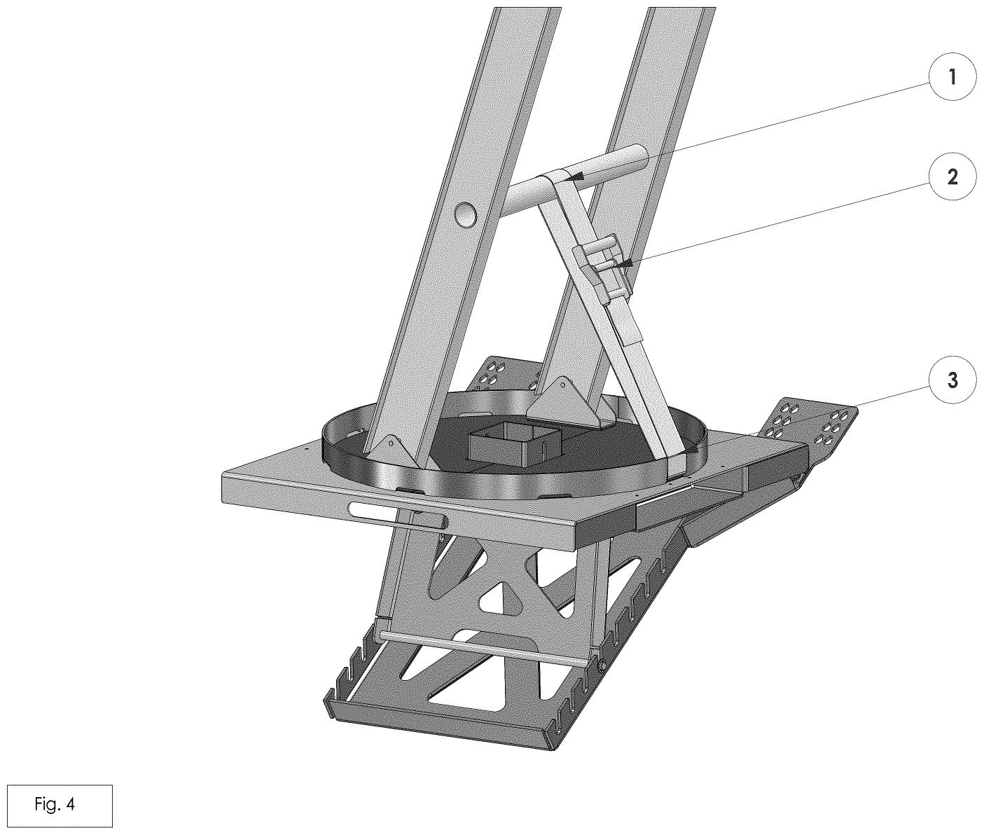

By buttressing the ladder's feet against the inner rim of the ladder stop, a robust lockdown strap and fastener establishes a third, tripodal leg that securely attaches the center of the ladder's first rung to one of the eight ‘tie-down’ slots located on the outer rim of the 360-degree ladder stop, FIG. 1 (8), FIG. 4 (1,2,3). [Note: CCOHS recommendations for: “portable ladders,” which specifically emphasizes, “Bottom Bracing” and instructs user to: “(a). Place the ladder on a firm, level footing. (b). Use a ladder with slip-resistant feet or secure blocking. (c). Brace or Tie the bottom of the ladder.”].

These tie-down slots serve two functions: they provide secure tie down, attachment points for the ladder and they also double as drainage slots, allowing for effective liquid drainage. This design ensures that any accumulated water or precipitation on the platform can drain seamlessly through the slots, maintaining a dry and slip-free surface. Thus, the platform can offer enhanced safety and usability, even in adverse weather conditions.

### Stable Triangular Support Points

This configuration effectively immobilizes the ladder, creating three stable tripodal, triangular points of support that evenly distribute the load's force. The circular configuration of the ladder stop accommodates ladders of various widths, allowing them to buttress securely against the stop at two tangential points aligned with the ladder feet, FIG. 4 (1,2,3).

### Versatile Anchoring with 360-Degree Ladder Stop

With the novel 360-degree ladder stop, users can easily maneuver the ladder in any direction within the full 360-degree range, FIG. 16 (1,2,3), allowing for readjustment and repositioning as needed FIG. 4. This feature simplifies rooftop work by requiring only one ladder setup while providing the flexibility to adapt to different angles and positions. By eliminating the need for multiple adjustments, nuts, bolts, or pin-locks, this design can streamline ladder placement, enhancing safety, convenience and efficiency in rooftop operations.

### Pump Jack Housing for Scaffolding and Walking Platforms

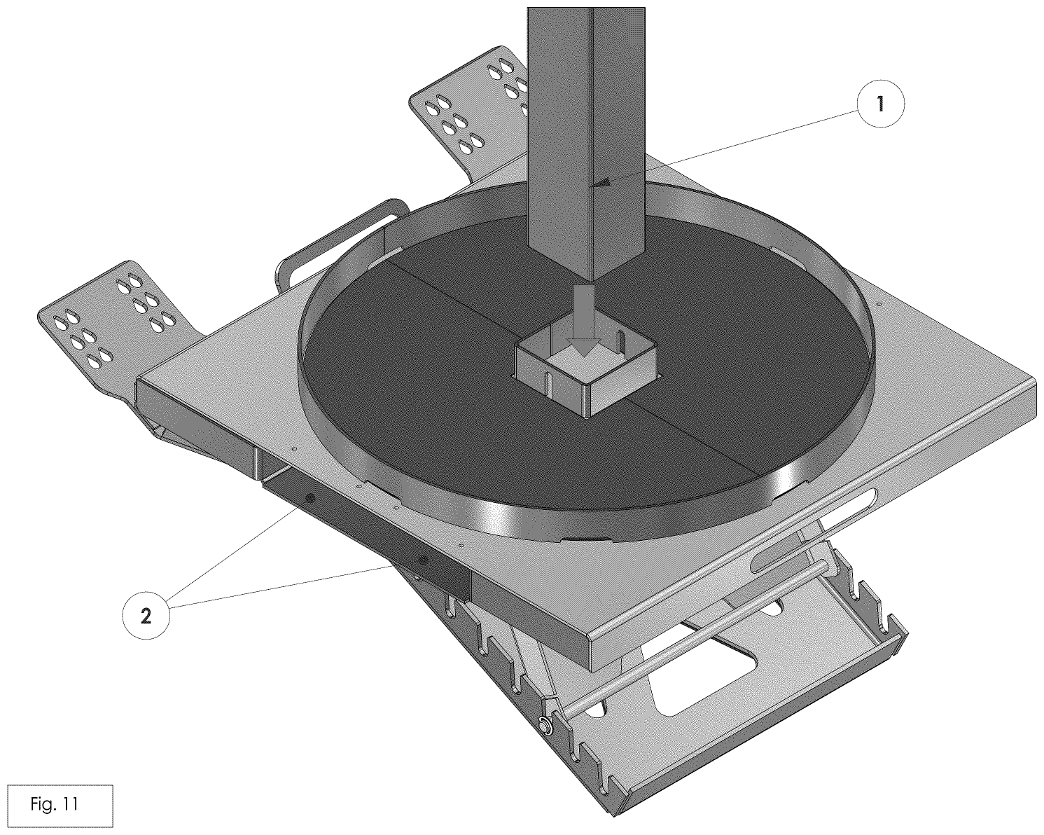

An additional embodiment of the present invention incorporates a mounted pump jack housing (square post anchor), situated at the center of the circular ladder stop FIG. 1 (4), FIG. 2 (4), and FIG. 11. This specially designed pump jack housing can serve as a reliable support structure for pump jack poles that can enable the utilization of scaffolding and walking platform configurations.

### Secure Attachment of Walking Planks

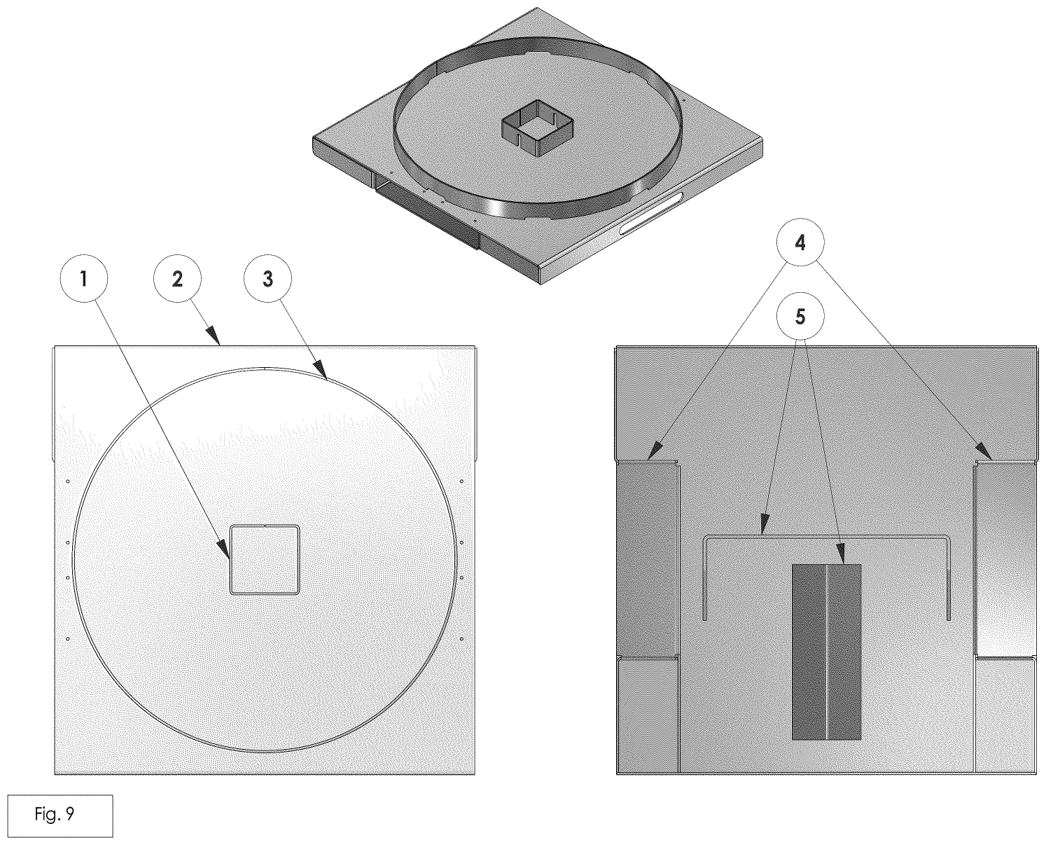

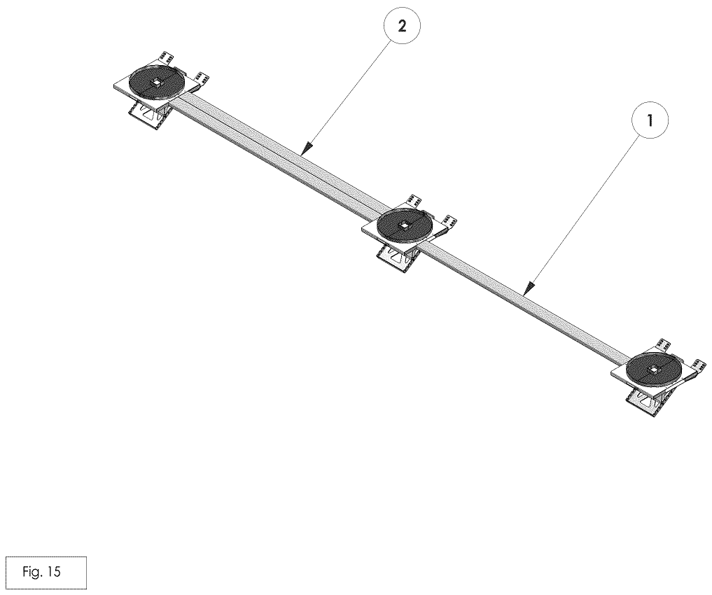

In another embodiment, the platform's frame is equipped with sturdy sleeves on both sides, FIG. 11 (2) and FIG. 9 (4), with precisely positioned drilled, wood screw holes, FIG. 2 (3). These drilled holes are specifically designed to securely attach the walking planks, similar to the existing roof brackets shown in FIG. 2 (3). These sleeves serve as reliable attachment points for the walking planks, as depicted in FIG. 1 (7), FIG. 2 (2), FIG. 11 (2), and operationally viewed in FIG. 15 (1,2), ensuring a stable and secure walking surface.

The walking plank housing can accommodate either a single 2×6 walking plank, FIG. 15 (1), or two 2×6 planks positioned side-by-side, FIG. 15 (2). To ensure a secure connection, the planks are fastened to the housing using four wood screws, FIG. 2 (3). This configuration expands the available workspace, promoting enhanced productivity and enabling safe and convenient access.

Moreover, when using a single 2×6 walking plank, the platform offers three positioning options-forward, center, or back location within the sleeve, FIG. 15 (1). This flexibility allows the user to adjust the position of the plank to suit their specific needs and preferences.

### Ergonomic Design with Non-Slip Rubber Membrane

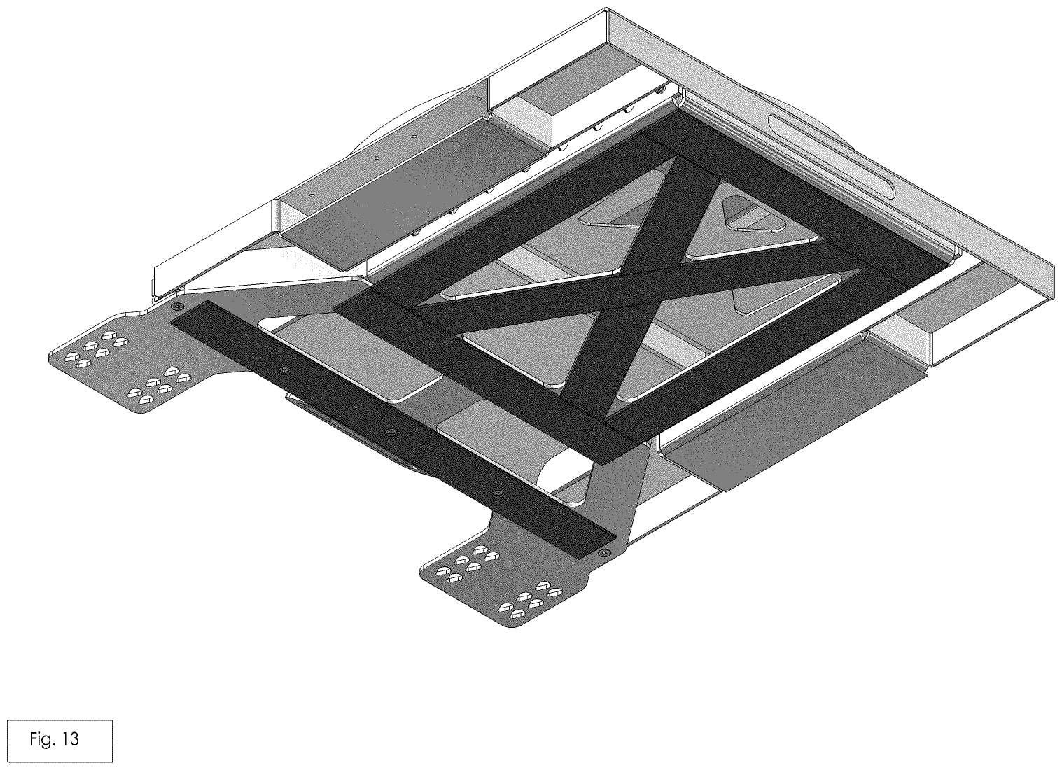

The present invention is designed with ergonomic considerations, facilitating easy carrying and gripping, FIG. 2 (1). It is constructed using a durable, lightweight, premium alloy. Additionally, the invention incorporates a non-slip rubber membrane firmly attached to the underside of its base plate, FIG. 5 (6) and FIG. 13. This non-slip material prevents the apparatus from sliding or slipping on pitched roof surfaces. This can ensure a stilled placement. As a result, the invention can be securely fastened to the roof using the nail bed.

### VARIATION AND EMBODIMENT

The present invention is embodied in two distinct versions, each tailored to serve different market segments and price points. One version is designed for residential use, specifically for homeowners, while the other version is intended for commercial use by professionals.

The homeowner version of the roof platform can be made of composite materials, providing a cost-effective solution. It is specifically designed to accommodate the more standard pitch options found in most residential houses, and can ensuring compatibility and ease-of-installation. This version offers homeowners a practical and affordable option for their roofing needs.

On the other hand, the commercial version of the roof platform is constructed with alloy materials, offering enhanced durability and strength. It provides greater versatility in adapting to various pitch options encountered in commercial settings, making it suitable for professionals who work on diverse commercial roofs. The commercial version's robust design can handle heavy loads, akin to those encountered with scaffolding systems, and can provide a stable working platform for professionals.

Accordingly, the present embodiments can be considered illustrative rather than restrictive, with the invention intended to encompass all changes and modifications falling within the scope of the appended claims.

What is claimed is:

1. A heavy load capacity, portable, horizontal, adjustable roof platform supporting a ladder and pump jack anchoring system, comprising:
(a) An upper platform configuration centered around a 360-degree ladder stop that anchors a ladder (of variable widths), in all directions, said ladder stop comprising:
(i) A circular rim forming the outer edge of the ladder stop, providing a structural boundary and secure stop.
(ii) A high-friction, anti-slip surface covering the platform base and inner rim of the ladder stop, preventing ladder slippage.
(iii) Eight equally spaced “tie-down” slots distributed along the outer rim of the ladder stop, facilitating secure attachment of the ladder.
(iv) A robust lockdown strap and fastener system for use within each tie-down slot, creating a secure connection between the center of the ladder's first rung and the ladder stop.
(v) Drainage slots integrated into the tie-down slots, enabling effective liquid drainage from the platform.
(vi) Triangular support points formed by the ladder feet abutting the inner rim of the ladder stop, ensuring stable load distribution.
(vii) Tangential contact points on the ladder stop's inner rim, providing secure bracing for ladders of various widths.
(viii) Full 360-degree maneuverability, allowing easy adjustment and repositioning of the ladder in any direction.
(ix) Simplified setup with a minimalistic design, reducing the need for multiple ladder set configurations.
(x) Compatibility with standard pitch options, ranging from 4/12 to 16/12, including increments of 6/12, 8/12, 10/12, 12/12, and 14/12.

2: The roof platform according to claim 1 further comprising:
(a) A support bracket for achieving a horizontally-level platform, said support bracket:
(i) Being adjustable to accommodate various pitch options, including standard pitch options ranging from 4/12 to 16/12, with increments of 6/12, 8/12, 10/12, 12/12, and 14/12.
(ii) Being Securely fastened to the upper platform, ensuring stability and structural integrity.
(iii) A reinforced structural configuration on the underside of the base platform to sustain heavy load capacities that incorporates a “lateral rib” constructed from a formed sheet metal of which includes two wedges (for clearance), holes that connect pivot connection to platform, and triangular, truss support.
b) A central pump jack housing (square post anchor), for accommodating a pump jack pole.
c) A tool-less fastener configuration for anchoring of the ladder to the 360 degree platform.
d) A hinge mechanism connecting the upper platform to the lower roofing jack support platform, allowing for adjustable positioning, stability, and enabling a collapsible configuration.
e) Walking plank housing located on either side of the base platform that supports either a single 2×6 walking plank or two 2×6 walking side-by-side.
f) A dual-purpose handle for carrying the platform and as a “tie-down” in a zero-pitch (collapsed into flattened position) configuration for extreme pitches.
g) Two nail beds to securely attach the platform to the roof.
